(19) United States
(12) Patent Application Publication
(10) Pub. No.: US 2024/0311421 A1
(43) Pub. Date: Sep. 19, 2024

(54) Multiple Dataset Search Based On a Visual Query

(71) Applicant: Google LLC, Mountain View, CA (US)

(72) Inventors: Utsav Lathia, San Francisco, CA (US); Sundeep Vaddadi, Los Gatos, CA (US)

(21) Appl. No.: 18/182,467

(22) Filed: Mar. 13, 2023

(51) Int. Cl. G06F 16/532; G06F 16/538; G06F 16/583; G06V 10/77

(52) U.S. Cl. CPC G06F 16/532; G06F 16/538; G06F 16/583; G06V 10/7715

(57) ABSTRACT

Systems and methods disclosed herein can leverage an embedding model to generate an image embedding for image data. The image embedding can then be utilized to determine relevant search results in each of a plurality of datasets. The systems and methods may include a pure embedding search for one dataset and a multimodal search for another dataset. One or more of the datasets may be selected for search based on one or more contexts associated with the user and/or the image. The search results may then be provided simultaneously to a user computing system.

### FIELD

The present disclosure relates generally to searching multiple datasets with a visual query. More particularly, the present disclosure relates to generating an image embedding based on an image query and searching multiple datasets based on the image embedding.

### BACKGROUND

Images can provide data that may not be succinctly described by text. Similarly, image queries can provide additional details that may not be captured by a brief text query. Therefore, image queries may enable a user to provide a detailed query without tediously writing a long string of text. The detailed query can be helpful when a user is attempting to find more information on an object.

Additionally, the search results provided to the user may not be associated with the information and/or actions the user wants. In particular, the search results may be associated with tangential and/or irrelevant information. The search results may be one dimensional and may only include one type of information and/or one type of resource.

### SUMMARY

Aspects and advantages of embodiments of the present disclosure will be set forth in part in the following description, or can be learned from the description, or can be learned through practice of the embodiments.

One example aspect of the present disclosure is directed to a computing system. The system can include one or more processors and one or more non-transitory computer-readable media that collectively store instructions that, when executed by the one or more processors, cause the computing system to perform operations. The operations can include obtaining image data. The image data can be descriptive of one or more images. The one or more images can include one or more image features. The operations can include processing the image data with an embedding model to generate an image embedding. The image embedding can be associated with the one or more image features. The operations can include determining one or more general search results by searching a first database based on the image embedding. In some implementations, the first database can include a global database associated with a plurality of web resources. The operations can include determining one or more specialized search results by searching a second database based on the image embedding. The second database can differ from the first database. In some implementations, the second database can include a specialized database. The operations can include providing the one or more general search results and the one or more specialized search results for display in a search results interface.

Another example aspect of the present disclosure is directed to a computer-implemented method. The method can include obtaining, by a computing system including one or more processors, image data. The image data can be descriptive of one or more images. The one or more images can include one or more image features. The method can include obtaining, by the computing system, context data associated with the image data. The context data can be descriptive of a particular context. The method can include processing, by the computing system, the image data with an embedding model to generate an image embedding. The image embedding can be associated with the one or more image features. The method can include determining, by the computing system, one or more general search results by searching a first database based on the image embedding. In some implementations, the first database can include a global database associated with a plurality of web resources. The method can include determining, by the computing system, a specialized database associated with the particular context. The method can include determining, by the computing system, one or more specialized search results by searching a second database based on the image embedding. The second database can differ from the first database. In some implementations, the second database can include the specialized database. The method can include providing, by the computing system, the one or more general search results and the one or more specialized search results for display in a search results interface.

Another example aspect of the present disclosure is directed to one or more non-transitory computer-readable media that collectively store instructions that, when executed by one or more computing devices, cause the one or more computing devices to perform operations. The operations can include obtaining image data. The image data can be descriptive of one or more images. The one or more images can include one or more image features. The operations can include processing the image data with an embedding model to generate an image embedding. The image embedding can be associated with the one or more image features. The operations can include processing the image data to determine one or more text labels associated with the one or more image features. The one or more text labels can be associated with a classification for the one or more image features. The operations can include determining one or more first search results by searching a first database based on the image embedding. The first database can be associated with a set of first resources. The operations can include determining one or more second search results by searching a second database based on the image embedding and the one or more text labels. The second database can differ from the first database. In some implementations, the second database can be associated one or more second resources. The operations can include providing the one or more first search results and the one or more second search results for display in a search results interface.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example multi-dataset search system according to example embodiments of the present disclosure.

FIG. 2 depicts a block diagram of an example embedding and token based search according to example embodiments of the present disclosure.

FIG. 3 depicts a flow chart diagram of an example method to perform multiple database search according to example embodiments of the present disclosure.

FIG. 4 depicts a block diagram of an example embedding and context based search according to example embodiments of the present disclosure.

FIG. 5 depicts a block diagram of an example multiple dataset search system according to example embodiments of the present disclosure.

FIG. 6 depicts illustrations of example search results interfaces according to example embodiments of the present disclosure.

FIG. 7 depicts a flow chart diagram of an example method to perform context-based search result determination according to example embodiments of the present disclosure.

FIG. 8 depicts a flow chart diagram of an example method to perform multiple dataset search result determination according to example embodiments of the present disclosure.

FIG. 9A depicts a block diagram of an example computing system that performs multiple dataset search according to example embodiments of the present disclosure.

FIG. 9B depicts a block diagram of an example computing device that performs multiple dataset search according to example embodiments of the present disclosure.

FIG. 9C depicts a block diagram of an example computing device that performs multiple dataset search according to example embodiments of the present disclosure.

Reference numerals that are repeated across plural figures are intended to identify the same features in various implementations.

### DETAILED DESCRIPTION

Generally, the present disclosure is directed to systems and methods for multiple dataset search with a visual query. In particular, the systems and methods can leverage an image embedding of an image query to determine search results from a plurality of datasets. For example, image data may be obtained to be utilized as an image query. The image data can be processed by an embedding model to generate an image embedding associated with one or more image features of the image data. The image embedding can then be utilized to search multiple datasets to determine one or more search results from each of the datasets that can then be provided to the user.

An image can be processed with one or more machine-learned models to determine one or more text labels associated with one or more objects in the image. The one or more text labels can then be utilized as a text query to search for search results associated with the image. However, the text label-based search may suffer from the same limitations as traditional text queries (e.g., may provide too general of results associated with the text label instead of detailed results that match the image query).

Alternatively and/or additionally, the image may be processed with an embedding model (e.g., a machine-learned embedding model) to generate an image embedding that may be descriptive of one or more image features in the image. The use of an image embedding can provide additional detail that may not be captured in a text label-based search. The image embedding may map the image data to an embedding space. Search results can then be determined based on embeddings associated with content stored in a dataset. For example, one or more other image embeddings may be similar to and/or the same as the image embedding associated with the image. Data associated with the similar image embeddings can then be obtained in order to provide search results to a user.

In some implementations, the search results may be determined based on both an image embedding and one or more text labels. For example, the one or more text labels may be utilized to determine a plurality of candidate search results, and the image embedding may be utilized to rank the plurality of candidate search results to determine which search results to provide to the user. Alternatively and/or additionally, the image embedding may be utilized to determine a plurality of candidate search results, and the one or more text labels may be utilized to rank the plurality of candidate search results to determine which search results are provided to the user.

Alternatively and/or additionally, the image can be processed with a tokenizer block to determine and/or generate one or more visual tokens (e.g., tokenized image features). The one or more visual tokens can then be utilized to determine one or more search results. In some implementations, the one or more visual tokens can determine a plurality of candidate search results, and an image embedding can be utilized to rank the plurality of candidate search results to determine which search results to provide to the user and at what position. Alternatively and/or additionally, the image embedding may be utilized for determining candidate search results, and the visual token(s) may be utilized to determine a rank.

Regardless of the technique utilized, a search with a visual query (e.g., image data that may include one or more images) may not provide satisfactory search results upon first search instance. A user may adjust the search preferences and/or criteria to limit the scope of resources searched, may broaden the scope of the resources search, may select a particular type of search results to obtain, and/or may remove search result type restrictions. The refinement can be tedious and non-intuitive.

The systems and methods disclosed herein can be utilized to search a plurality of datasets (e.g., a plurality of databases) to determine a set of search results for each of the plurality of datasets to provide to the user. The search results from a plurality of datasets can mitigate tedious search refinement and provide a search results interface that can include information from a plurality of datasets associated with different resources associated with different tasks (e.g., a general search and/or a specialized search).

Additionally and/or alternatively, the systems and methods disclosed herein can utilize an image embedding associated with a visual query to search each of the plurality of datasets to determine visually similar search results that may be associated with different resources, different tasks, and/or different actions.

For example, a visual query including image data can be obtained. The image data can be processed with an embedding model to generate an image embedding. The image embedding can then be utilized to search a first database (e.g., a general database associated with general search results) to determine one or more first search results. The one or more first search results can be associated with one or more search result embeddings that are determined to be associated with the image embedding. Additionally and/or alternatively, the image embedding can then be utilized to search a second database (e.g., a specialized database associated with specialized search results (e.g., search results associated with a particular action)) to determine one or more second search results. The one or more second search results can be associated with one or more search result embeddings that are determined to be associated with the image embedding. The one or more first search results and the one or more second search results can then be provided for display in a search results interface. The search result embeddings for each database and the image embedding may be associated with the same embedding space. In some implementations, the search result embeddings for each database and the image embedding may be associated with a particular learned distribution. The search results interface may include different panels associated with the different databases and/or may display the search results of the different databases intermingled with one another.

The first dataset may include a general dataset associated with general search results. The second dataset may include a specialized dataset associated with specialized search results (e.g., a dataset associated with a specific type of search result (e.g., image search results, location search results, product search results, scholarly search results, and/or verified search results), a dataset associated with a specific object type (e.g., a dataset associated with a particular object), a dataset associated with a specific application (e.g., an image gallery application, a social media application, a shopping application, and/or a music application), and/or a dataset associated with a specific action (e.g., a booking action, a navigation action, a purchase action, and/or an augmented-reality and/or virtual-reality experience action)).

Which datasets to utilize for search may be predetermined and/or determined based on a user selection. However, some datasets may be useful for some visual searches and may be irrelevant for other visual searches. Additionally, a user may not understand the purposes of different datasets and/or which dataset is pertinent for their particular request.

The systems and methods disclosed herein can obtain and/or determine context data that can be utilized to determine a particular dataset to search. In particular, context data associated with the image data and/or the user can be obtained and processed to determine a particular database to search. For example, a location, a user search history, a time, and/or a user browsing history may be associated with a particular action type, a particular object, and/or a specific type of search result (e.g., an image of a shirt in a shopping mall may be associated with a price check search, while an image of a poster of a shirt may be associated with a search to find a purchase link to purchase the specific shirt). In some implementations, the context data may be determined based on an object type classification and/or one or more features in the image. The object type can then be utilized to determine a specific dataset to utilize. For example, a house classification may be utilized to select a multiple listing service (MLS) database to search with the image embedding. Alternatively and/or additionally, an identification of a user's dog in an image may be utilized to determine a user's camera roll and/or image gallery is to be searched.

In some implementations, different search techniques may be utilized for searching different datasets. For example, an image embedding without a text label or visual token may be utilized for determining search results for a first dataset (e.g., a general database), and the image embedding with the one or more text labels (and/or with the one or more visual tokens) may be utilized for determining search results for the second dataset (e.g., a specialized database).

In some implementations, the multiple dataset search can include a general search across web resources and an advertisement search across a plurality of stored advertisement datasets.

The systems and methods of the present disclosure provide a number of technical effects and benefits. As one example, the system and methods can provide a search results interface that includes search results from a plurality of datasets in which the search results include search results determined based on an image embedding. The search results may be based on embedding similarity and/or a learned distribution to provide visually similar search results regardless of the dataset searched. The systems and methods may utilize the same and/or similar learned embeddings paces across different datasets, which may include using the same and/or similar embedding models across different datasets.

Another technical benefit of the systems and methods of the present disclosure is the ability to leverage context data to determine a specialized dataset to search. For example, the systems and methods disclosed herein can obtain and/or determine context data that can then be utilized to determine a specific specialized database (e.g., a MLS database, a local database, and/or a product database) to search using an image embedding of the image query. The specialized database search may be performed with a general search to provide both general and specialized search results.

Another example of technical effect and benefit relates to improved computational efficiency and improvements in the functioning of a computing system. For example, the systems and methods disclosed herein can leverage an embedding model to generate an image embedding that can be utilized to determine search results embeddings associated with the image embedding that can be utilized to determine search results for a plurality of datasets, which may include a general dataset and/or a specialized dataset. The use of an image embedding to search a plurality of datasets can be utilized to determine visually similar and relevant search results associated with different web resources that may include a general dataset and/or a specialized dataset. The multiple dataset search can reduce the computational cost of search refinement and may reduce the computational cost and improve search result determination when compared to text label determination search then refinement.

With reference now to the Figures, example embodiments of the present disclosure will be discussed in further detail.

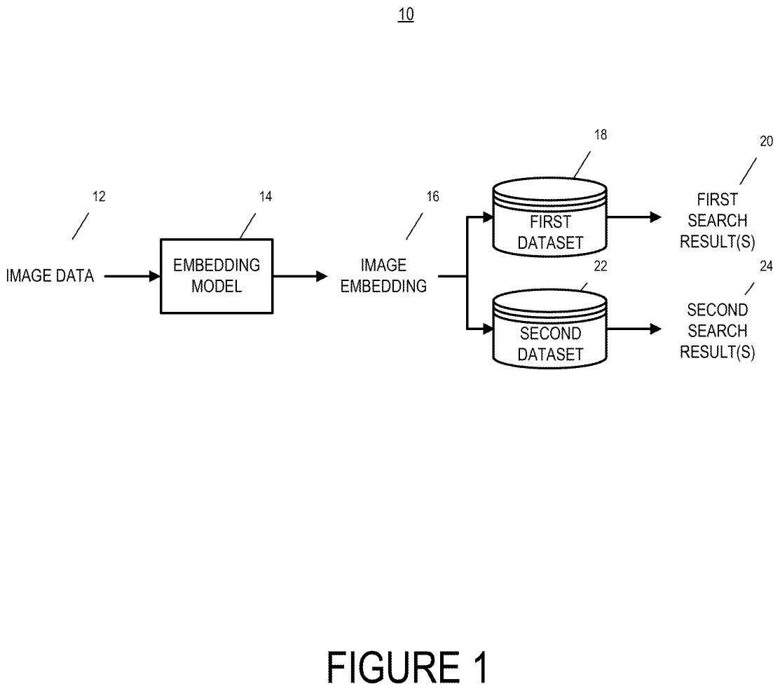

FIG. 1 depicts a block diagram of an example multi-dataset search system 10 according to example embodiments of the present disclosure. In particular, image data 12 can be obtained, processed to generate an image embedding 16, and utilized to determine one or more search results associated with a plurality of datasets (e.g., a first dataset 18 and a second dataset 22). The image data 12 may be a visual query including one or more images obtained from a user. The image data 12 may be input via a user interface. The user interface can include a search interface of a search application, a marketplace application, a social media application, and/or a viewfinder application. In some implementations, the image data 12 can be associated with a live video feed of a user environment captured via a mobile computing device.

The image data 12 can be processed with an embedding model 14 to generate an image embedding 14. The embedding model 12 may have been trained to map an image to an embedding space based on one or more features in the image. In some implementations, the image embedding 16 can be associated with one or more image features in the image data 12. The one or more image features can be descriptive of objects depicted in the one or more images of the image data 12.

The image embedding 16 can be processed to determine a plurality of search results. In particular, a first dataset 18 and a second dataset 22 can be searched based on the image embedding 16. For example, the image embedding 16 can be processed to determine a set of first search results 20 of the first dataset 18 based on one or more first embeddings that have a threshold pairwise similarity to the image embedding 16. Additionally and/or alternatively, the image embedding 16 can be processed to determine a set of second search results 24 of the second dataset 22 based on one or more second embeddings that have a threshold pairwise similarity to the image embedding 16. The set of first search results 20 and the set of second search results 24 may then be provided for display. The search results may be provided for display with the one or more images of the image data 12. In some implementations, the set of first search results 20 and the set of second search results 24 may be determined and/or ranked based in part on the image embedding 16, one or more textual labels for the image data 12, and/or one or more visual tokens for the one or more image features.

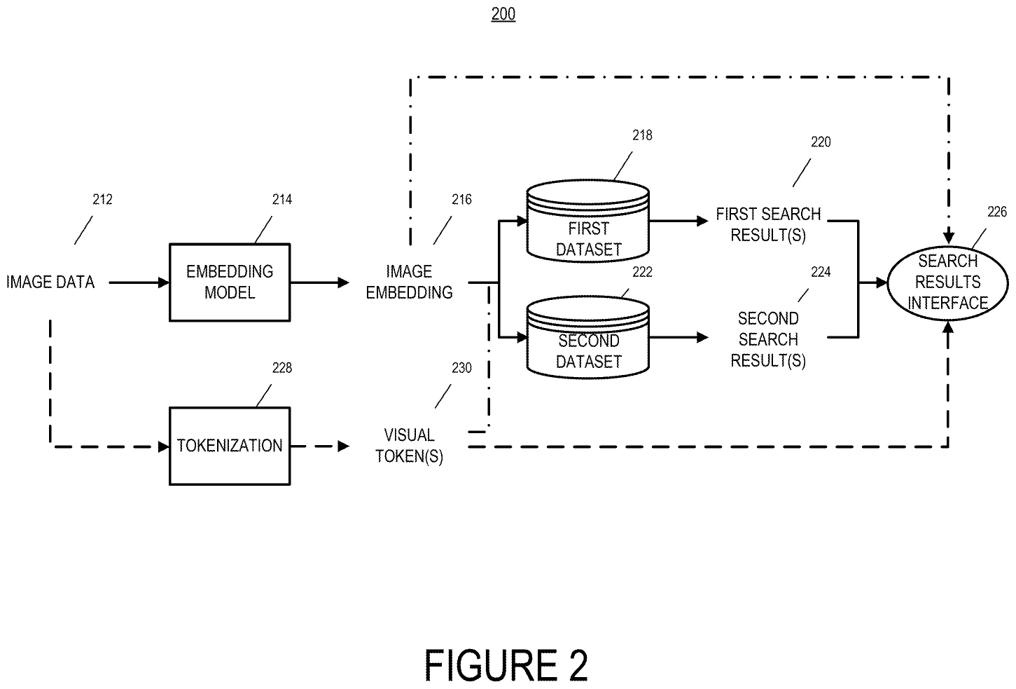

FIG. 2 depicts a block diagram of an example embedding and token based search 200 according to example embodiments of the present disclosure. In particular, image data 212 can be obtained, processed to generate an image embedding 216, and utilized to determine one or more search results associated with a plurality of datasets (e.g., a first dataset 218 and a second dataset 222). The plurality of search results (e.g., the set of first search results 220 and the set of second search results 224) may then be ranked and/or filtered based on one or more visual tokens 230. The ranking may then be utilized to determine a position for the search results within the search results interface 226. The image data 212 may be a visual query including one or more images obtained from a user (e.g., one or more images obtained from a user computing system). The image data 212 may be input via a user interface (e.g., an upload interface, a selection interface, and/or an image capture interface). In some implementations, the image data 212 can be associated with a live video feed of a user environment captured via a mobile computing device.

The image data 212 can be processed with an embedding model 214 (e.g., a machine-learned embedding model) to generate an image embedding 214. The embedding model 212 may have been trained to generate an image embedding 216 that is similar to embeddings for images depicting similar objects to those depicted in the image data 212. In some implementations, the image embedding 216 can be associated with one or more image features in the image data 212. The one or more image features can be descriptive of objects depicted in the one or more images of the image data 212.

Additionally and/or alternatively, the image data 212 and/or the image embedding 216 may be processed with a tokenization block 228 to determine one or more visual tokens 230. The one or more visual tokens 230 can be associated with the one or more image features of the image data 212. The tokenization block 228 can include one or more machine-learned tokenizers trained to generate and/or determine tokens based on features in an image.

The image embedding 216 can be processed to determine a plurality of search results. In particular, a first dataset 218 (e.g., a general dataset associated with a plurality of web resources) and a second dataset 222 (e.g., a specialized dataset associated with a specific type of data) can be searched based on the image embedding 216 and/or the one or more visual tokens 230. For example, the image embedding 216 can be processed to determine a set of first search results 220 of the first dataset 218 based on one or more first embeddings that have a threshold pairwise similarity to the image embedding 216. Additionally and/or alternatively, the image embedding 216 can be processed to determine a set of second search results 224 of the second dataset 222 based on one or more second embeddings that have a threshold pairwise similarity to the image embedding 216. The set of first search results 220 and the set of second search results 224 may then be ranked and/or filtered based on the one or more visual tokens 230.

Alternatively and/or additionally, the one or more visual tokens 230 can be utilized to determine a set of first search results 220 of the first dataset 218 based on content that includes features associated with the one or more visual tokens 230. In some implementations, the one or more visual tokens 230 can be utilized to determine a set of second search results 224 of the second dataset 222 based on content that includes features associated with the one or more visual tokens 230. The set of first search results 220 and the set of second search results 224 may then be ranked and/or filtered based on the image embedding 216.

In some implementations, the set of first search results 220 may be determined based on the image embedding 216, while the set of second search results 224 may be determined based on the one or more visual tokens 230. Alternatively and/or additionally, the set of second search results 224 may be determined based on the image embedding 216, while the set of first search results 220 may be determined based on the one or more visual tokens 230.

The set of first search results 220 and the set of second search results 224 can then be provided for display via a search results interface 226. The search results interface 226 can provide the set of first search results 220 and the set of second search results 224 in the same panel and/or in separate panels. The position of the search results within the search results interface 226 may be determined based on a determined relevance ranking of search results.

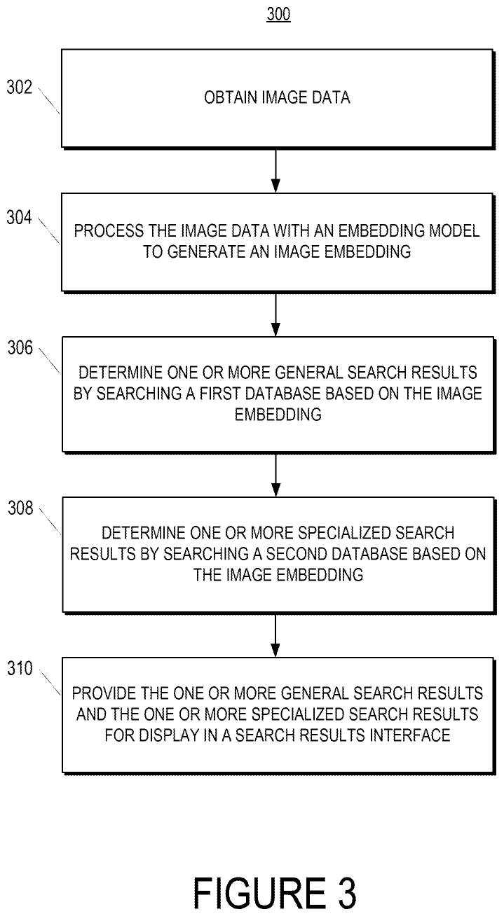

FIG. 3 depicts a flow chart diagram of an example method to perform according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a computing system can obtain image data. The image data can be descriptive of one or more images. The one or more images can include one or more image features. The image data may be associated with a live video feed. Alternatively and/or additionally, the one or more images may include one or more cropped images. The cropped images may be generated based on an object detection, an object classification, and/or a user selection. The image data may be generated and/or augmented by one or more machine-learned models. For example, the image data may include one or more bounding boxes generated by an object detection model, one or more classifications generated by one or more classification models, and/or one or more cropped images generated by one or more segmentation models.

At 304, the computing system can process the image data with an embedding model to generate an image embedding. The image embedding can be associated with the one or more image features. The image embedding model can include one or more encoders. In some implementations, the image embedding model may have been trained to generate an image embedding in an embedding space. The image embeddings may be associated with feature vectors for classifying one or more objects in the image. For example, the image embedding may be associated with a learned distribution associated with a particular bag, a particular place, and/or a particular object type. The image embedding model may be trained on a training dataset that includes a plurality of training images and a plurality of training labels.

In some implementations, the computing system can obtain a selection of a portion of the one or more images. The computing system can segment the portion of the one or more images to generate a segmented image and process the segmented image with the embedding model to generate the image embedding. The image can be segmented based on a bounding box, a user gesture, and/or based on a predetermined image panel. The segmentation may be based on an output of an object detection model and/or may be performed by a machine-learned segmentation model.

In some implementations, the computing system can determine one or more visual tokens associated with the one or more image features. The one or more visual tokens can be determined with a tokenizer block. The tokenizer block may include one or more machine-learned models. In some implementations, the one or more visual tokens can be determined by determining one or more visual tokens associated with a classification for the one or more image features.

At 306, the computing system can determine one or more general search results by searching a first database based on the image embedding. The first database can include a global database associated with a plurality of web resources. In some implementations, the one or more general search results can be determined based on the image embedding being associated with one or more first search result embeddings associated with the one or more general search results. The one or more general search results can include one or more first image search results. The one or more search result embeddings can include one or more first image embeddings associated with one or more first image features of the one or more first image search results. The computing system may determine a plurality of general search results by searching the first database based on the image embedding and the one or more visual tokens. The plurality of general search results can include the one or more general search results.

In some implementations, the plurality of general search results can be obtained based on the one or more visual tokens. The plurality of general search results can be ranked based on the image embedding, and the computing system can determine a positioning of the one or more general search results in the search results interface based on the image embedding.

At 308, the computing system can determine one or more specialized search results by searching a second database based on the image embedding. The second database can differ from the first database. In some implementations, the second database can include a specialized database. The one or more specialized search results can be determined based on the image embedding being associated with one or more second search result embeddings associated with the one or more specialized search results. In some implementations, the one or more specialized search results can include one or more second image search results. The one or more second search result embeddings can include one or more second image embeddings associated with one or more second image features of the one or more second image search results. The computing system may determine a plurality of specialized search results by searching the second database based on the image embedding and the one or more visual tokens. The plurality of specialized search results can include the one or more specialized search results.

In some implementations, the plurality of specialized search results can be obtained based on the one or more visual tokens. The plurality of specialized search results can be ranked based on the image embedding. The computing system may determine a positioning of the one or more specialized search results in the search results interface based on the image embedding.

At 310. The computing system can provide the one or more general search results and the one or more specialized search results for display in a search results interface. The search results interface can include at least a subset of the plurality of general search results and at least a subset of the plurality of specialized search results. The search results interface may provide the search results for display with at least a portion of the one or more images. The search results interface may be provided for display with a viewfinder window.

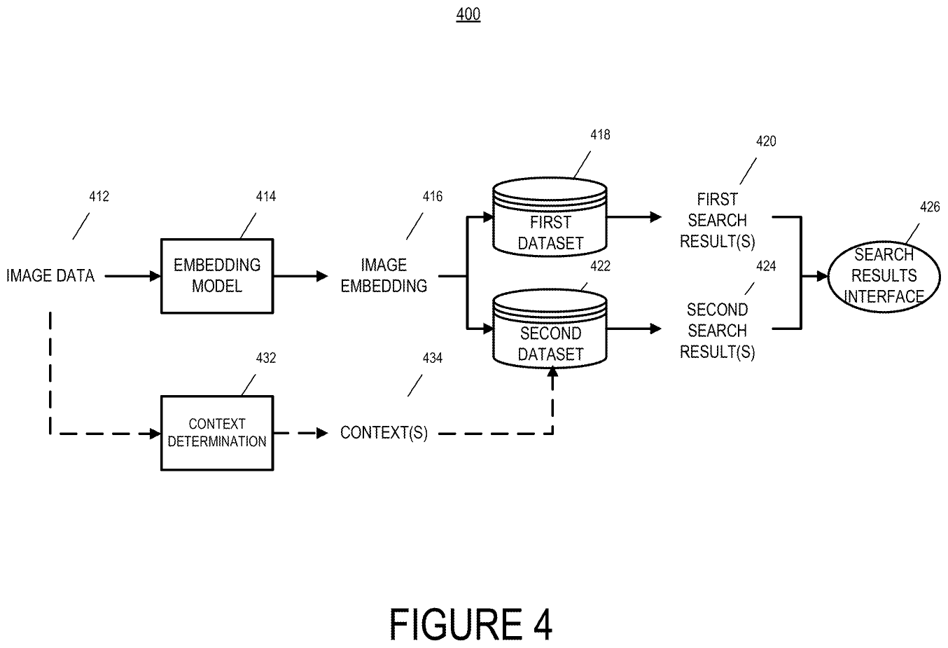

FIG. 4 depicts a block diagram of an example embedding and context based search 400 according to example embodiments of the present disclosure. In particular, image data 412 can be obtained and searched in which the search includes searching one or more particular datasets selected based on a determined context 434. For example, a visual query can be obtained that includes image data 412. The image data 412 can be processed with an embedding model 414 to generate an image embedding 416. The image embedding 416 can be generated based at least in part one or more image features in the one or more images of the image data 412.

The image data 412 can be processed with a context determination block 432 to determine a context 434 associated with the one or more images of the image data 412. The context determination block 432 can include one or more machine-learned models. The context 434 may be determined based on user data (e.g., a user profile, user search history, user browsing history, user purchase history, user preferences, and/or other user data), image metadata, location data, global data (e.g., global trends), regional data (e.g., regional trends), and/or other data. The context 434 may be determined based on processing the image data 412 with one or more classification models to determine an image classification and/or one or more object classifications. The classification(s) can then be utilized to determine the context 434.

The context 434 can then be utilized to select a first dataset 418 and/or a second dataset 422 to search with the image embedding 416. The first dataset 418 may be a general dataset that is predetermined and/or fixed. The second dataset 422 may be selected based on the context 434. In some implementations, the first dataset 418 and/or the second dataset 422 may be selected based on the context 434. For example, a location-specific dataset may be selected based on a determination that the image data 412 was obtained and/or generated at a particular location. Alternatively and/or additionally, an action-specific dataset (e.g., search results associated with recipes) may be selected based on previous recipe search performed by the user.

The image embedding 412 can be processed to determine a set of first search results 420 associated with the first dataset 418 and a set of second search results 424 associated with the second dataset 422. The set of first search results 420 and the set of second search results 424 may be provided for display via a search results interface 426. In some implementations, the determined context 434 may be indicated in the search results interface 426 via one or more user interface elements. Additionally and/or alternatively, the set of first search results 420 and the set of second search results 424 may be provided in separate panels and may be provided for display with panel headings (or labels) that are associated with the specific dataset (e.g., “general search results” for a general dataset, “context based search results” for specialized search results, and/or booking options for search results associated with a specialized dataset associated with making reservations for a restaurant, a hotel, a therapist, and/or another booking service). In some implementations, the search results may be provided adjacent to one another.

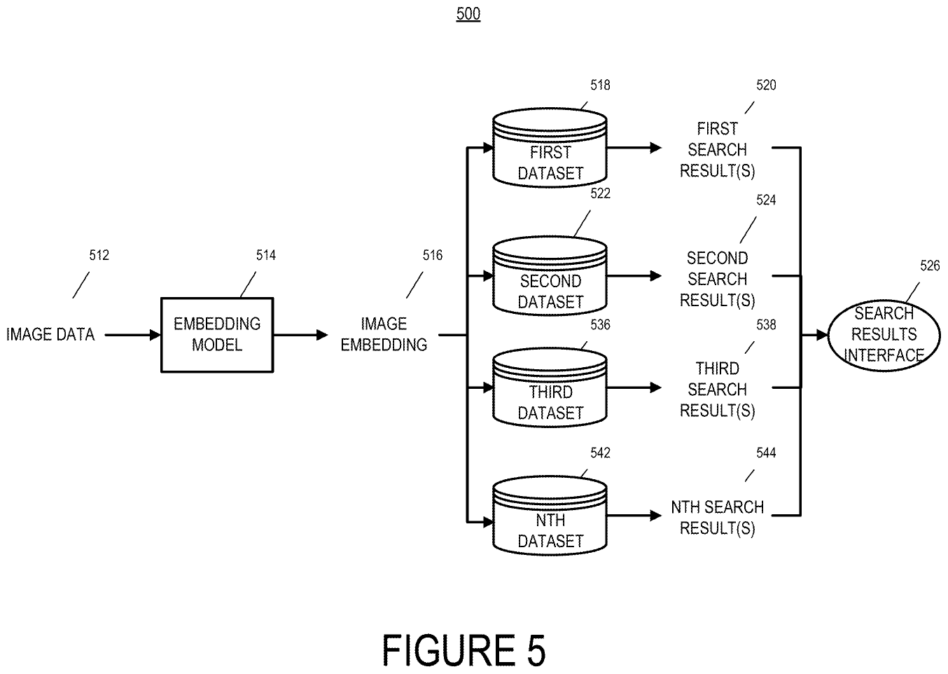

FIG. 5 depicts a block diagram of an example multiple dataset search system 500 according to example embodiments of the present disclosure. Although the figures above depict two datasets, the systems and methods disclosed herein can include any number of datasets. The plurality of datasets may include a mix of predetermined datasets, user selected datasets, and/or automatically selected datasets based on context. In some implementations, the plurality of datasets can include a general dataset and/or a plurality of different specialized datasets (e.g., one or more location-specific datasets, one or more advertisement specific datasets, one or more action specific datasets, one or more general datasets, and/or one or more object type specific datasets).

For example, image data 512 descriptive of a visual query may be obtained. The image data 512 can include one or more images, user data, location data, previous file storage data, and/or other metadata. The image data 512 can be processed with an embedding model 514 to generate an image embedding 516.

A plurality of datasets can then be selected for search. The first dataset 520 may be selected based on the particular application being utilized by the user to input the visual query. The second dataset 522 may be selected based on global trends (e.g., a particular news event). The third dataset 536 may be selected based on the most recent searches performed by the user (e.g., a makeup marketplace dataset can be obtained based on the most recent user searches being associated with lipstick shopping). The Nth dataset 542 may be selected based on the location of the user (e.g., a dataset associated with items available to the user's location).

One or more first search results 520 associated with the first dataset 518, one or more second search results 524 associated with the second dataset 522, one or more third search results 538 associated with the third dataset 536, and/or one or more nth search results 544 associated with the Nth dataset 542 can be determined based on the image embedding 516.

At least a subset of the search results can then be provided to the user computing system via the search results interface 526. The search results interface 526 can display the search results in particular positions based on a determined relevance, based on the source of the search result, and/or based on the type of search result.

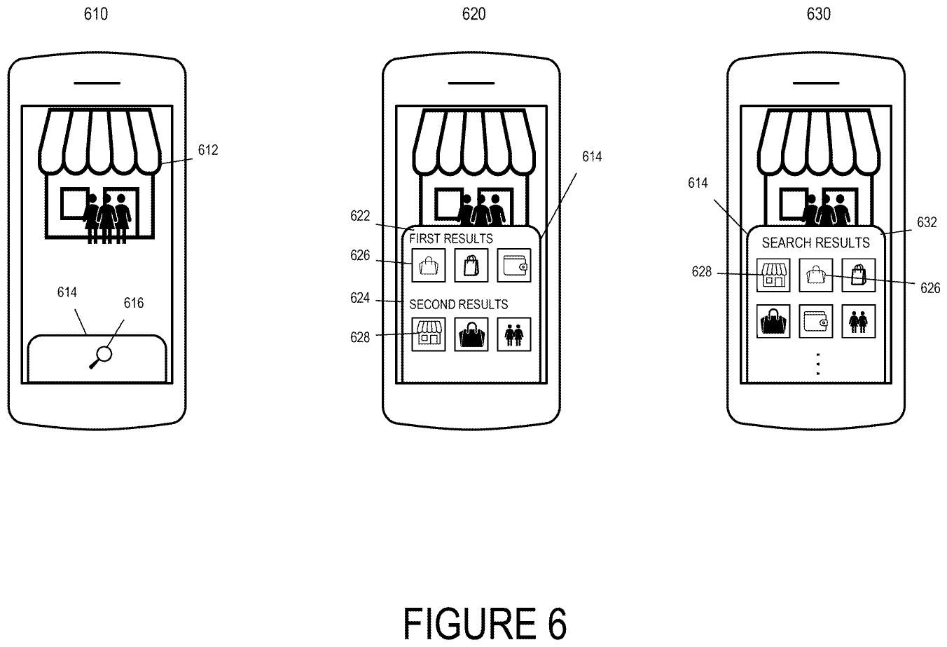

FIG. 6 depicts illustrations of example search results interfaces according to example embodiments of the present disclosure. In particular, at 610, an initial interface is provided for display. The initial interface can include a viewfinder 612 for capturing images, which may include a live camera feed. The initial interface may include a task bar 614, which can include a search user interface element 616. The search user interface element 616 can be selected by the user. In response to the selection of the search user interface element 616, an image can be captured with the viewfinder. The image can be processed to search a plurality of datasets to determine a set of first search results and a set of second search results.

The task bar 614 can then pop-up and/or expand to display at least a subset of the plurality of search results. At 620, the different sets of search results associated with different datasets are provided for display in separate panels. For example, the set of first search results including a first search result 626 can be provided in a first search result panel 622, and the set of second search results including a second search result 628 can be provided in a second search result panel 624. Alternatively and/or additionally, the different sets of search results can be intermingled and provided for display in positions based on relevance scores. For example, at 630, a single search results panel 632 is provided for display in the task bar of the interface. The first search result 626 may be provided for display adjacent to the second search result 628 with the second search result 628 being provided for display in a first position based on a determined relevance score being higher than a determined relevance score for the first search result 626.

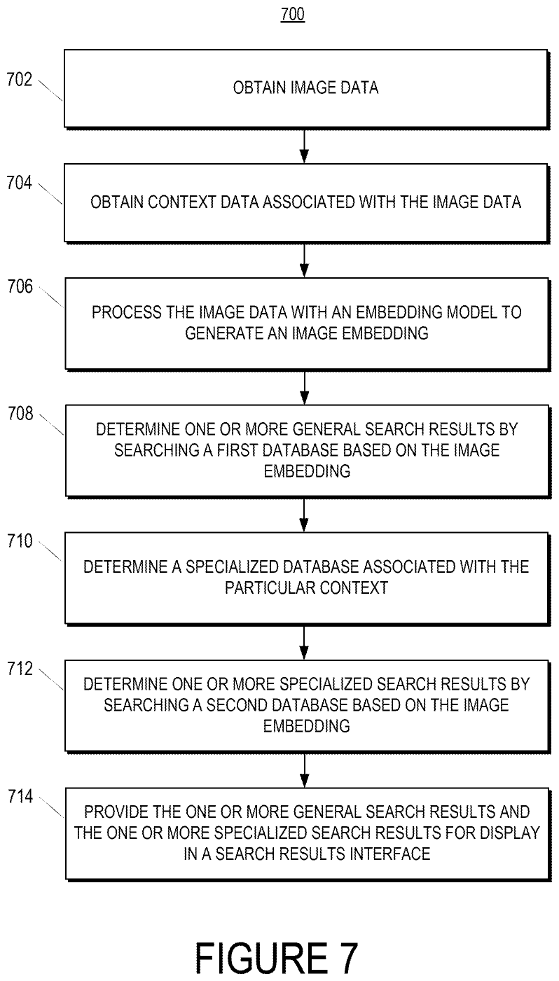

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can obtain image data. The image data can be descriptive of one or more images. The one or more images can include one or more image features. The image data may be obtained and/or generated with an image capture device of a user computing system (e.g., a camera of a mobile device (e.g., a smart phone)). The one or more image features may be descriptive of one or more objects in the environment.

At 704, the computing system can obtain context data associated with the image data. The context data can be descriptive of a particular context. In some implementations, the context data can include historical data associated with a user search history, user browsing history, and/or user purchase history. The context data can include location data associated with a location where the image data was captured. In some implementations, the context data can be associated with a trending social media topic, a trending search topic, and/or fashion trends. The context data may be associated with a time of day, a day of the week, a month, a season, and/or a year. The context data can be associated with one or more previously captured images.

Additionally and/or alternatively, the context data may be associated with a particular application interface being utilized. For example, the context data may be descriptive of a viewfinder search application, a browser search application, a social media application, and/or an image gallery application.

At 706, the computing system can process the image data with an embedding model to generate an image embedding. The image embedding can be associated with the one or more image features. The embedding model can include one or more encoder models. The embedding model may have been trained to generate one or more feature embeddings. In some implementations, the embedding model may be trained to generate a feature embedding for each of the one or more image features. The image embedding may be an embedding space and may be associated with a learned distribution associated with a particular object and/or a particular object type.

At 708, the computing system can determine one or more general search results by searching a first database based on the image embedding. The first database can include a global database associated with a plurality of web resources. The one or more general search results can be associated with one or more image search results. The first database may be associated with a general search engine.

At 710, the computing system can determine a specialized database associated with the particular context. The specialized database can be associated with a specific web resource. In some implementations, the specialized database can be associated with a local database associated with a user that provided the image data. The specialized database can include a plurality of specialized search results. Additionally and/or alternatively, each of the plurality of specialized search results can be associated with an action link for performing one or more actions. In some implementations, the specialized database may be determined based on one or more learned distributions associated with the image embedding. A specialized database may be determined based on an image classification, an object classification, and/or a user selection. For example, in response to determining the image depicts a house, a property listing database may be selected for specialized search. Alternatively and/or additionally, in response to determining the image depicts one or more clothing items, a clothing marketplace database may be selected for specialized search.

At 712, the computing system can determine one or more specialized search results by searching a second database based on the image embedding. The second database can differ from the first database. In some implementations, the second database can include the specialized database. The one or more specialized search results can be associated with one or more product search results. The second database may be associated with a localized search engine (e.g., an application specific search, a platform specific search, and/or a web resource specific search).

At 714, the computing system can provide the one or more general search results and the one or more specialized search results for display in a search results interface. The one or more general search results and the one or more specialized search results may be provided in separate panels and/or may be intermingled. The search results may be selected based on visual tokens and may be ranked based on the image embeddings and/or the context data.

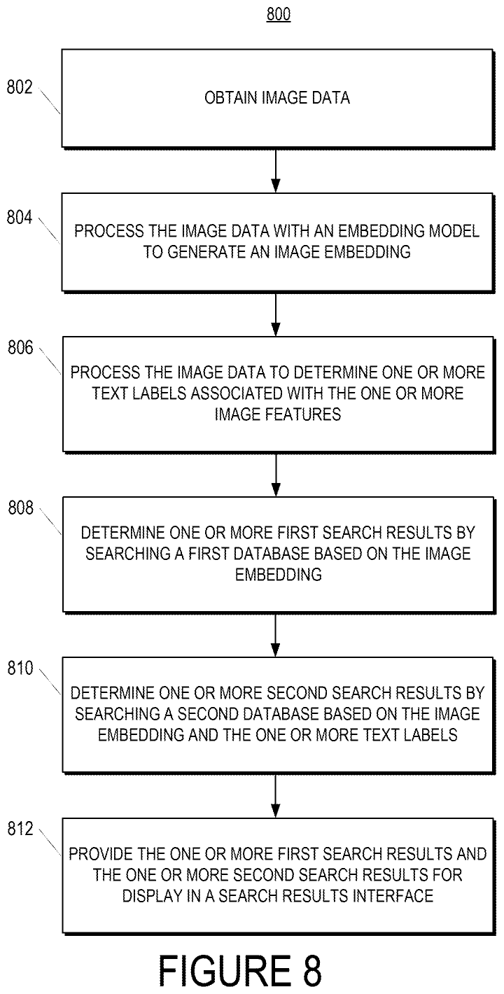

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain image data. The image data can be descriptive of one or more images. The one or more images can include one or more image features. The image data can be user image data descriptive of the users environment. In some implementations, the image data can include user selected image data. Additionally and/or alternatively, the image data may be obtained by an overlay application that includes ambient computing that continually processes the data provided for display on a user computing device. The image data may be a portion of a captured image and/or a portion of a displayed user interface. The portion may be determined based on a prediction of what a user is interested in based on a focal point, a determined gaze location, a received user input, semantic analysis of the image and/or displayed user interface, a user context, and/or based on one or more machine-learned preferences.

At 804, the computing system can process the image data with an embedding model to generate an image embedding. The image embedding can be associated with the one or more image features. The embedding model can be trained to generate similar embeddings for visually similar objects. In some implementations, the embedding model can be trained to generate embedding groupings based on object types.

At 806, the computing system can process the image data to determine one or more text labels associated with the one or more image features. The one or more text labels can be associated with a classification for the one or more image features. The one or more text labels may be determined by processing the image data with a classification model. The classification model and the embedding model may be jointly trained. The one or more text labels may be associated with an object type, a product type, a style type, a price range label, an availability type, an entity label associated with a manufacturer and/or retailer of a product, and/or condition label (e.g., new, old, worn out, and/or condition grading.

At 808, the computing system can determine one or more first search results by searching a first database based on the image embedding. The first database can be associated with a set of first resources. The one or more first search results can be associated with a first search result type (e.g., a web page search result, a document search result, a product search result, and/or an image search result). The set of first resources may be associated with trusted databases, general databases, product marketplaces, localized files, cloud stored files, social media web platforms, scholarly resources, government resources, and/or encyclopedia web resources.

At 810, The computing system can determine one or more second search results by searching a second database based on the image embedding and the one or more text labels. The second database can differ from the first database. In some implementations, the second database can be associated with one or more second resources. The one or more second search results can be associated with a second search result type (e.g., a web page search result, a document search result, a product search result, and/or an image search result). The set of second resources may be associated with trusted databases, listing databases (e.g., a local, regional, and/or general multiple listing service), general databases, product marketplaces, localized files, cloud stored files, social media web platforms, scholarly resources, government resources, and/or encyclopedia we resources. The first database and the second database may differ. The first set of search results and/or the second set of search results may be determined based on embedding similarity (e.g., pairwise similarity) between the image embedding and one or more search result embeddings. The second set of search results may be associated with advertisement content and may provide one or more options to view a particular web page, purchase a product, and/or perform one or more other actions. The one or more second search results may be search results that meet a relevance threshold based on embedding similarity and/or term based relevance.

In some implementations, the first database and the second database may include different datasets associated with differing search results. The first database and second database may include embeddings mapped to a same and/or similar embedding space. For example, the plurality of embeddings of the first database and the plurality of embeddings of the second database may be generated with the same and/or similar embedding model. In some implementations, the first database and the second database may include one or more overlapping resources. Additionally and/or alternatively, the first database and the second database may store data and/or structure search results in different formats. For example, the first database may be associated with a general search result format, and the second database may be associated with action-based search results.

At 812, the computing system can provide the one or more first search results and the one or more second search results for display in a search results interface. The search results interface can include the one or more first search results displayed in a first panel. Additionally and/or alternatively, the search results interface can include the one or more second search results displayed in a second panel. The first panel and the second panel can be separated. In some implementations, the search results interface may simultaneously provide the first panel, the second panel, and the one or more images of the image data for display. The search results interface can include a plurality of action links associated with performing one or more actions associated with the one or more second search results.

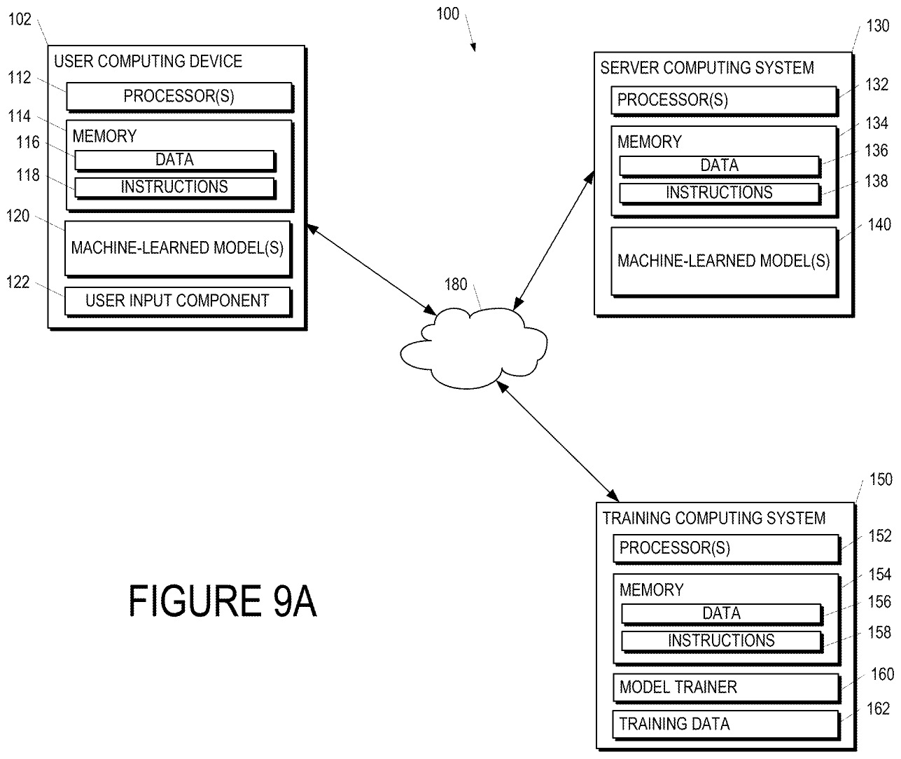

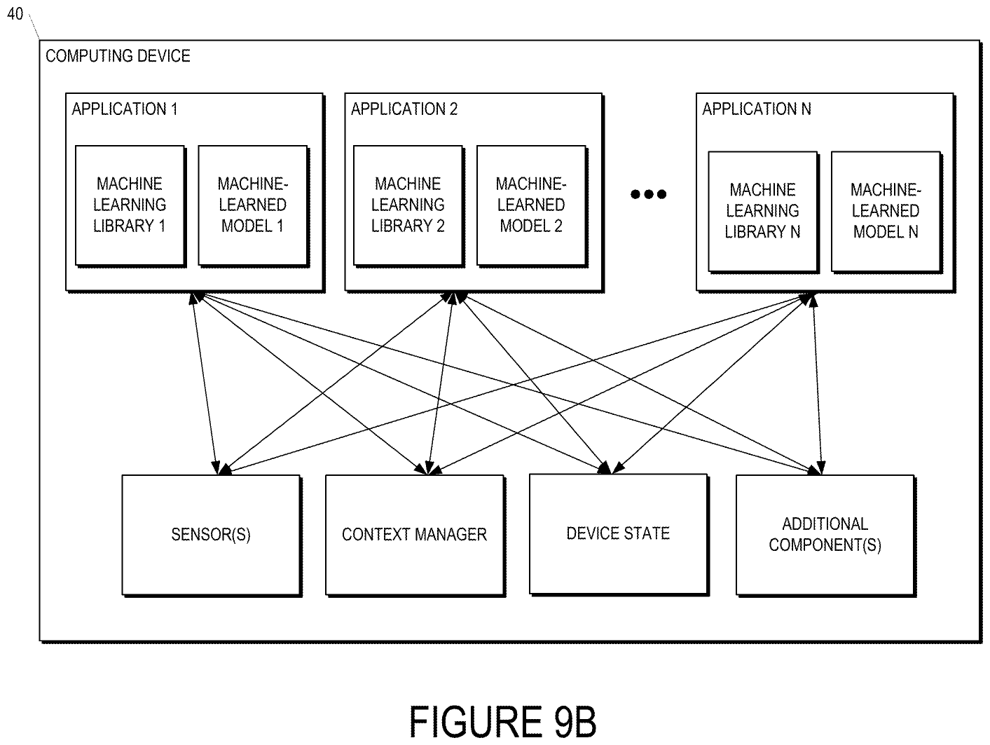

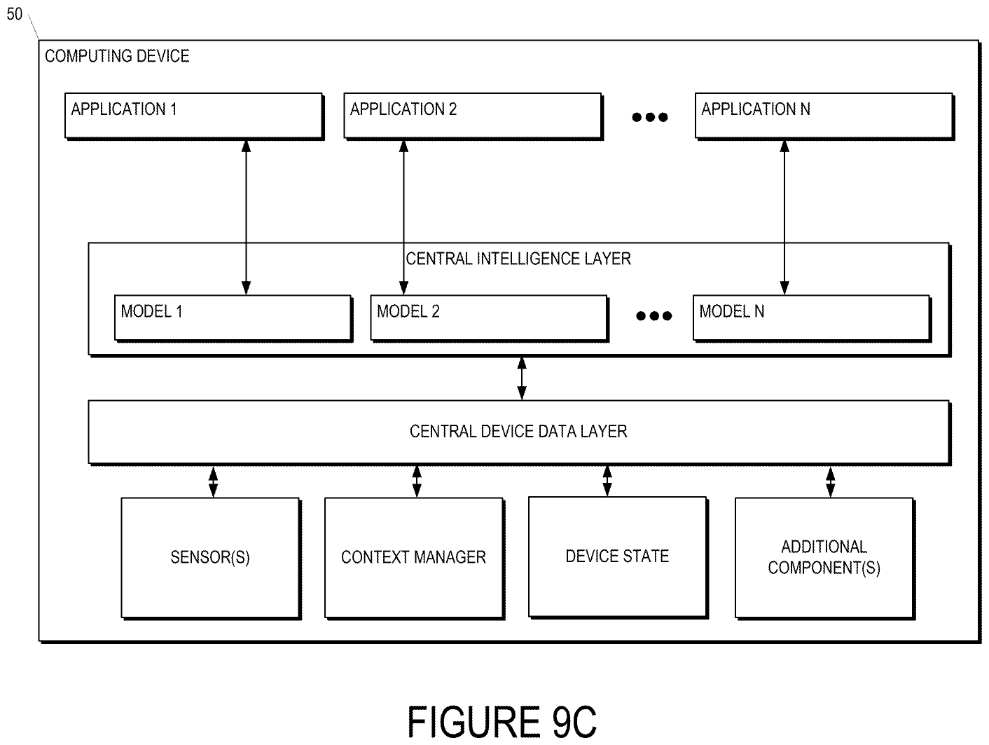

FIG. 9A depicts a block diagram of an example computing system 100 that performs multiple dataset search according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more embedding models 120. For example, the embedding models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example embedding models 120 are discussed with reference to FIGS. 1-6.

In some implementations, the one or more embedding models 120 can be received from the server computing system 130 over network 180, stored in the user computing device memory 114, and then used or otherwise implemented by the one or more processors 112. In some implementations, the user computing device 102 can implement multiple parallel instances of a single embedding model 120 (e.g., to perform parallel multiple dataset search across multiple instances of an image query).

More particularly, the one or more embedding models 120 can be utilized to generate image embeddings and/or search result embeddings that can be utilized to determine one or more search results. The search results may be determined based on embedding similarity, embedding classification and classification label based search, embedding mapping, and/or based on a learned distribution associated with the embedding.

Additionally or alternatively, one or more embedding models 140 can be included in or otherwise stored and implemented by the server computing system 130 that communicates with the user computing device 102 according to a client-server relationship. For example, the embedding models 140 can be implemented by the server computing system 140 as a portion of a web service (e.g., a multiple dataset search service). Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned embedding models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIGS. 1-6.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the embedding models 120 and/or 140 based on a set of training data 162. The training data 162 can include, for example, training images, training embeddings, training labels, training image pairs, training image triplets, and/or training classifications.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

FIG. 9A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 9B depicts a block diagram of an example computing device 40 that performs according to example embodiments of the present disclosure. The computing device 40 can be a user computing device or a server computing device.

The computing device 40 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 9B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 9C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 9C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 9C, the central device data layer can communicate with a number of other components of the computing device, such as, for example, one or more sensors, a context manager, a device state component, and/or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system, the system comprising:
one or more processors; and
one or more non-transitory computer-readable media that collectively store instructions that, when executed by the one or more processors, cause the computing system to perform operations, the operations comprising:
obtaining image data, wherein the image data is descriptive of one or more images, and wherein the one or more images comprise one or more image features;
processing the image data with an embedding model to generate an image embedding, wherein the image embedding is associated with the one or more image features;
determining one or more general search results by searching a first database based on the image embedding, wherein the first database comprises a global database associated with a plurality of web resources;
determining one or more specialized search results by searching a second database based on the image embedding, wherein the second database differs from the first database, and wherein the second database comprises a specialized database; and
providing the one or more general search results and the one or more specialized search results for display in a search results interface.

2. The system of claim 1, wherein the one or more general search results are determined based on the image embedding being associated with one or more first search result embeddings associated with the one or more general search results.

3. The system of claim 2, wherein the one or more general search results comprise one or more first image search results, and wherein the one or more search result embeddings comprise one or more first image embeddings associated with one or more first image features of the one or more first image search results.

4. The system of claim 1, wherein the one or more specialized search results are determined based on the image embedding being associated with one or more second search result embeddings associated with the one or more specialized search results.

5. The system of claim 4, wherein the one or more specialized search results comprise one or more second image search results, and wherein the one or more second search result embeddings comprise one or more second image embeddings associated with one or more second image features of the one or more second image search results.

6. The system of claim 1, wherein the operations comprise:
determining one or more visual tokens associated with the one or more image features;
determining a plurality of general search results by searching the first database based on the image embedding and the one or more visual tokens, wherein the plurality of general search results comprise the one or more general search results;
determining a plurality of specialized search results by searching the second database based on the image embedding and the one or more visual tokens, wherein the plurality of specialized search results comprise the one or more specialized search results; and
wherein the search results interface comprises at least a subset of the plurality of general search results and at least a subset of the plurality of specialized search results.

7. The system of claim 6, wherein the plurality of general search results are obtained based on the one or more visual tokens.

8. The system of claim 6, wherein the plurality of general search results are ranked based on the image embedding; and
determining a positioning of the one or more general search results in the search results interface based on the image embedding.

9. The system of claim 6, wherein the plurality of specialized search results are obtained based on the one or more visual tokens;
wherein the plurality of specialized search results are ranked based on the image embedding; and
determining a positioning of the one or more specialized search results in the search results interface based on the image embedding.

10. The system of claim 1, wherein the operations further comprise:
obtaining a selection of a portion of the one or more images;
segmenting the portion of the one or more images to generate a segmented image; and
processing the segmented image with the embedding model to generate the image embedding.

11. A computer-implemented method, the method comprising:
obtaining, by a computing system comprising one or more processors, image data, wherein the image data is descriptive of one or more images, and wherein the one or more images comprise one or more image features;
obtaining, by the computing system, context data associated with the image data, wherein the context data is descriptive of a particular context;
processing, by the computing system, the image data with an embedding model to generate an image embedding, wherein the image embedding is associated with the one or more image features;
determining, by the computing system, one or more general search results by searching a first database based on the image embedding, wherein the first database comprises a global database associated with a plurality of web resources;
determining, by the computing system, a specialized database associated with the particular context;
determining, by the computing system, one or more specialized search results by searching a second database based on the image embedding, wherein the second database differs from the first database, and wherein the second database comprises the specialized database; and
providing, by the computing system, the one or more general search results and the one or more specialized search results for display in a search results interface.

12. The method of claim 11, wherein the specialized database is associated with a specific web resource.

13. The method of claim 11, wherein the specialized database is associated with a local database associated with a user that provided the image data.

14. The method of claim 11, wherein the context data comprises historical data associated with a user search history.

15. The method of claim 11, wherein the context data comprises location data associated with a location where the image data was captured.

16. The method of claim 11, wherein the specialized database comprises a plurality of specialized search results, wherein each of the plurality of specialized search results is associated with an action link for performing one or more actions.

17. One or more non-transitory computer-readable media that collectively store instructions that, when executed by one or more computing devices, cause the one or more computing devices to perform operations, the operations comprising:
obtaining image data, wherein the image data is descriptive of one or more images, and wherein the one or more images comprise one or more image features;
processing the image data with an embedding model to generate an image embedding, wherein the image embedding is associated with the one or more image features;
processing the image data to determine one or more text labels associated with the one or more image features, wherein the one or more text labels are associated with a classification for the one or more image features;
determining one or more first search results by searching a first database based on the image embedding, wherein the first database is associated with a set of first resources;
determining one or more second search results by searching a second database based on the image embedding and the one or more text labels, wherein the second database differs from the first database, and wherein the second database is associated one or more second resources; and
providing the one or more first search results and the one or more second search results for display in a search results interface.

18. The one or more non-transitory computer-readable media of claim 17, wherein the search results interface comprises the one or more first search results displayed in a first panel, wherein the search results interface comprises the one or more second search results displayed in a second panel, and wherein the first panel and the second panel are separated.

19. The one or more non-transitory computer-readable media of claim 18, wherein the search results interface simultaneously provides the first panel, the second panel, and the one or more images of the image data for display.

20. The one or more non-transitory computer-readable media of claim 17, wherein the search results interface comprises a plurality of action links associated with performing one or more actions associated with the one or more second search results.
